(19) United States
(12) Patent Application Publication
(10) Pub. No.: US 2007/0168401 A1
(43) Pub. Date: Jul. 19, 2007

(54) User interface for piecemeal restore

(76) Inventors: Aditya Kapoor, Bellevue, WA (US); Wenlu Ma, Sammamish, WA (US); Craig G. Duncan, Issaquah, WA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/326,079

(22) Filed: Jan. 5, 2006

(51) Int. Cl. G06F 17/30

(52) U.S. Cl. 707/202

(57) ABSTRACT

This disclosure concerns systems and methods for restoring data. In one example, a method for piecemeal restoration of a database involves a computer system having a user interface and a selection device. The method begins when a query is sent to a database server application requesting a list of all offline filegroups for the database. Next, the list of all offline filegroups is received from the database server application. Then, the list of all offline filegroups is automatically presented on the user interface. Next, a list selection signal is received, indicative of the selection device designating one or more of the filegroups from the list. Finally, in response to the receipt of the list selection signal, a command is automatically formulated to bring the designated one or more filegroups online.

### BACKGROUND OF THE INVENTION

1. The Field of the Invention

The present invention relates to systems and methods for restoring data in a database. More particularly, embodiments of the invention relate to systems and methods for implementing piecemeal restore on a database.

2. Related Technology

Databases are used to store data in a logical and accessible fashion. A database is generally made up of a series of database files. Database files can generally be classified into two types of files, data files and log files. Sometimes the data files in a database are grouped together into filegroups for allocation and administration purposes.

Filegroups can be especially useful during backup and restore operations on a database. A database backup operation generally results in a duplicate copy of the data in a database. In the event of data corruption or data loss, the duplicate copy of the database data can be used to restore the database to the state it existed in at the time that the backup operation was performed on the database. However, database restore operations take time and can place a heavy demand on database system resources.

Frequently, certain filegroups of a database are more critical than others. The need for these critical filegroups to be brought online quickly is greater than the need for less critical filegroups to be brought online. This need has led to the development of a database restore operation known as “piecemeal restore.” Piecemeal restore allows databases including multiple filegroups to be restored in multiple stages. During the first stage of piecemeal restore, the most critical filegroup or filegroups will be restored. After the first stage, the filegroup(s) that were restored will be online and accessible to database users, while the filegroup(s) that have not yet been restored will be offline and will not be accessible to database users. The offline filegroup(s) can be restored during subsequent stages of the piecemeal restore operation. To allow distinct filegroups of the database to be restored in stages at different points in time, a piecemeal restore operation typically maintains checks to ensure that the database will be consistent in the end after all filegroups are restored and brought online.

One problem with current implementations of piecemeal restore operations is that a database administrator is often required to formulate one or more command line database queries to the database system before each stage of the piecemeal restore operation in order to determine which filegroups remain offline. Since a piecemeal restore operation occurs in stages, a database administrator can, at an intermediate stage, lose track of which filegroups have been brought online and which filegroups remain offline. The only way a database administrator can determine which filegroups are still offline is to formulate one or more queries requesting this information from the database system. The formulation of database queries is time consuming and database administrators can make mistakes in syntax that can cause the query to return an error or return erroneous results. The inability to automatically determine which files are offline before each stage of a piecemeal restore operation makes the task of executing each stage burdensome and inefficient for a database administrator.

Another problem with current implementations of piecemeal restore operations is that, in order to execute each stage, the database administrator is required to formulate a complex command line database command. The database command for each stage contains configuration information for the stage, including which filegroups should be brought online during the execution of the stage, what database the filegroups should be restored to, and any file location modifications or file name modifications for the files in the filegroups being brought online. The formulation of database commands presents obstacles similar to the formulation of database queries. Formulating database commands is time consuming and database administrators can make mistakes in syntax that can cause the command to return an error or return erroneous results. The requirement that a complex command be formulated in order to execute each stage of a piecemeal restore operation makes the task of executing each stage burdensome and inefficient for a database administrator.

Yet another problem with current implementations of piecemeal restore operations is that restarting a piecemeal restore operation requires the database administrator to formulate a complex restart command designating that all online filegroups be taken offline. Formulation of this command, like the commands designating configuration information for each stage, is time consuming and database administrators can make mistakes in syntax that cause the command to fail or not restart the piecemeal restore operation properly. The requirement that a complex command be formulated in order to restart a piecemeal restore operation makes this task burdensome and inefficient for a database administrator.

### BRIEF DESCRIPTION OF THE DRAWINGS

To further clarify various aspects of exemplary embodiments of the present invention, a more particular description of the invention will be rendered by reference to specific exemplary embodiments thereof which are illustrated in the appended drawings. It is appreciated that these drawings depict only exemplary embodiments of the invention and are therefore not to be considered limiting of its scope. The drawings are not drawn to scale. The invention will be described and explained with additional specificity and detail through the use of the accompanying drawings in which:

FIG. 1 illustrates an exemplary system for backing up file system data within a network;

FIG. 2 illustrates an exemplary database system;

FIG. 3A illustrates an exemplary graphical user interface for executing each stage of a piecemeal restore operation;

FIG. 3B illustrates another exemplary graphical user interface for formulating command to implement various aspects of a piecemeal restore operation;

FIG. 4 is a flowchart that discloses aspects of an exemplary process for piecemeal restore using a user interface;

FIG. 5 is a flowchart that discloses aspects of an exemplary process for modifying file destination during a piecemeal restore operation using a user interface; and

FIG. 6 is a flowchart that discloses aspects of an exemplary process for restarting a piecemeal restore operation using a graphical user interface.

### DETAILED DESCRIPTION OF EXEMPLARY EMBODIMENTS OF THE INVENTION

### I. An Exemplary Database Operations System

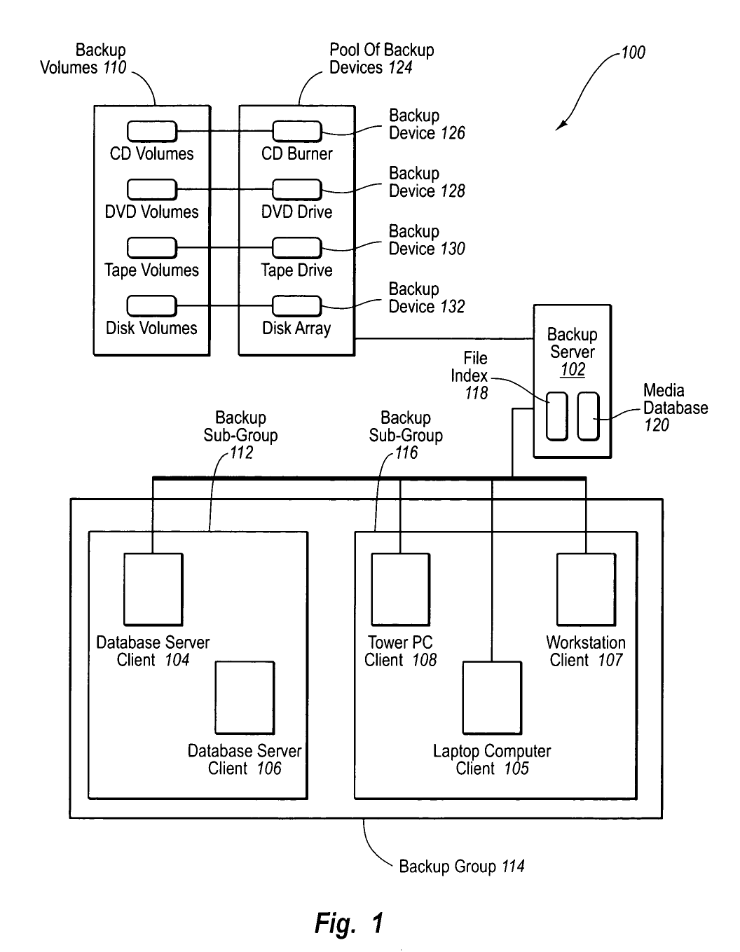

One operational environment suitable for embodiments of the present invention is shown in FIG. 1. FIG. 1 illustrates an exemplary file system data backup and recovery system (“DBRS”) 100 which generally functions to reproduce online file system data at a storage location and maintains location and obsolescence tracking information about the data. If the online version of the data is lost or corrupted, DBRS 100 can restore the data. In the event that the network in which DBRS 100 operates experiences a disaster, DBRS 100 can restore all DBRS 100 file systems to their original respective structures, as the file systems existed when written to storage.

An exemplary embodiment of DBRS 100 includes three basic components: a backup server 102, one or more clients 104, 105, 106, 107 and 108, and backup volumes 110 of data. Backup server 102 and clients 104, 105, 106, 107, and 108 are the entities which have the software necessary to run the DBRS 100 operations. Backup server 102 includes the programs and services that organize and manage the DBRS 100 functions. Clients 104, 105, 106, 107, and 108 include the programs and services that execute the DBRS 100 functions.

Backup server 102 manages data for its set of clients, such as client 104, 105, 106, 107 and 108. Clients 104, 105, 106, 107, and 108 represent machines on the network which deliver files to be backed up. Backup server 102 may incorporate the use of respective backup groups 112, 114, and 116 to organize the clients/data. Backup groups refer to sets of clients and/or data that are backed up together as a group. A single client can be included in multiple backup groups, exemplified by backup sub-group 112 and backup group 114.

To manage the data that is backed up from clients 104, 105, 106, 107, and 108, DBRS 100 relies on data tracking information, represented in FIG. 1 by a file index 118 and a media database 120 of backup server 102. The entries in file index 118 and media database 120 maintain content and location information describing all the data, both client machines and files, that has been backed up in the DBRS 100 environment.

File index 118 of backup server 102 is a browseable list of backed-up files organized according to each client. Each file on each client in the network that is backed up is listed in file index 118. An entry in file index 118 includes information about the file such as the file type, the time at which the file was backed up, and other information relating to the file, such as the client machine hosting the original file. Because a file may be backed up multiple times and the backup copies may be stored in multiple locations, an entry for a file in file index 118 may contain information concerning the backup location and time of backup for each backed up version of the file. The information in file index 118 concerning multiple backup locations and backup times for a particular file enables a user to identify a specific version of the file for retrieval. Entry information concerning multiple backups of a file can remain in file index 118 for any amount of time determined by an administrator.

While file index 118 tracks information concerning individual files, media database 120 tracks the locations at which the files are stored. In other words, media database 120 contains references to media storage locations. In operation, media database 120 receives an entry each time a backup group 112, 114, or 116 is backed up to a storage volume on DBRS 100. Just as with entries in file index 118, each entry will remain in media database 120 until an administrator removes the entry. Entries in media database 120 can also be removed if the corresponding data is overwritten.

Once the location information concerning the data is known, the data can be stored in different ways. For example, the data can be stored in media volumes on devices such as tape drives, hard disks, or removable disks accessible from backup server 102, as shown in FIG. 1, or accessible by way of a remote server. In an exemplary system for backing up data, data is stored in volumes on devices, as exemplified by backup volumes 110 and a pool 124 of backup devices 126, 128, 130 and 132. An example of storing data by device and volume is storing data on a disk array, with the data storage sub-grouped into disks. Another example of storing data by device and volume is storing data on a tape drive, with the data storage sub-grouped into specific tape volumes. A final example of storing data by device and volume is storing data on a remote server with the data storage sub-grouped into hard disks on the server. Although these examples are helpful in understanding possible configurations of devices and volumes, the ability of DBRS 100 to store data in devices and volumes is not limited to the examples given. In the most general sense, backup devices 126, 128, 130 and 132 of the pool 124 refer to a conceptual model of ways for storing data that are not limited to specific systems or devices.

The usefulness of backup devices 126, 128, 130 and 132 within DBRS 100 is further enhanced by the ability of backup devices 126, 128, 130 and 132 to store data of various types. Specifically, backup devices 126, 128, 130 and 132 can contain data of every file type. For example, backup copies of image files, program execution files, and document files can be stored together in backup devices 126, 128, 130 and 132.

One underlying aspect of backup devices 126, 128, 130 and 132 is the ability of backup devices 126, 128, 130 and 132 to speed retrieval of backed-up files in DBRS 100. For example, when a user requests a restore of a backed-up file, DBRS 100 can quickly retrieve the file if the file index 118 and media database 120 entries for the file contain highly specific location information including reference to backup devices 126, 128, 130 and 132, and the particular media that was used, such as, for example, the tape, CD, DVD, or other media that was used to store the file.

With regard to many features, including backing up to backup devices 126, 128, 130 and 132, DBRS 100 is initially configured to execute functions independently. However, an administrator has many capabilities to control the DBRS 100 functionality. Thus, an administrator can segregate files for storage according to different client and/or file characteristics and can define when a backup volume has become obsolete and should be removed. For example, an administrator could configure DBRS 100 to remove a backup volume from media database 120 after a specified period of time has elapsed since the backup was created. An administrator can also define backup groups 112, 114, and 116, which could include one or more clients and their files, directories, or file systems, or all the files on a client machine.

When accessing clients 104, 105, 106, 107, and 108, the administrator can work within an administrator GUI (not shown). The administrator GUI can be displayed on any DBRS 100 machine, allowing an administrator to interface with, and broker services for, any client 104, 105, 106, 107, or 108, regardless of the client platform. Another important aspect of the capabilities of an administrator involves the ability to specify the application environment. For example, an administrator can create records that specify instructions such as backup devices DBRS 100 will use and the number of clients defined. An administrator can also specify rules that the application will enforce within the backup and recovery environment, including backup scheduling and how long data will be protected before it is recycled.

In addition to administrator capabilities, DBRS 100 also incorporates a system for recovery of lost data. When client data is lost or corrupted, users or an administrator can browse the recoverable files in file index 118 and then create a report to describe the status of the lost data or the location, tracked by media database 120, of the contents in the volumes on backup devices 126, 128, 130 and 132. The user can then recover the lost data to a user specified point in time. When a request is made to recover lost data, DBRS 100 locates the data sought and directs recovery of the file(s). Data can be recovered to client 104, 105, 106, 107, or 108 where the data originated, or to another specified client.

Furthermore, DBRS 100 has the ability to perform in heterogeneous environments and can run on a variety of different platforms. For example, backup software on a UNIX® server can support Windows® clients or vice-versa. Backup data for any device or volume related to a client can be read and the data of the device or volume can be restored to a user-specified point in time by any DBRS 100 server, regardless of the server platform. Backup data from any system client 104, 105, 106, 107, or 108 can coexist in a single backup device or on a single media set, regardless of the platform of client 104, 105, 106, 107, or 108.

### II. An Exemplary Database System

The exemplary DBRS 100 outlined above performs backup and restore operations on files on a network. In addition to the capabilities of the exemplary system discussed above, the exemplary DBRS can support a variety of additional applications and features. One such application incorporates database backup and restore operations.

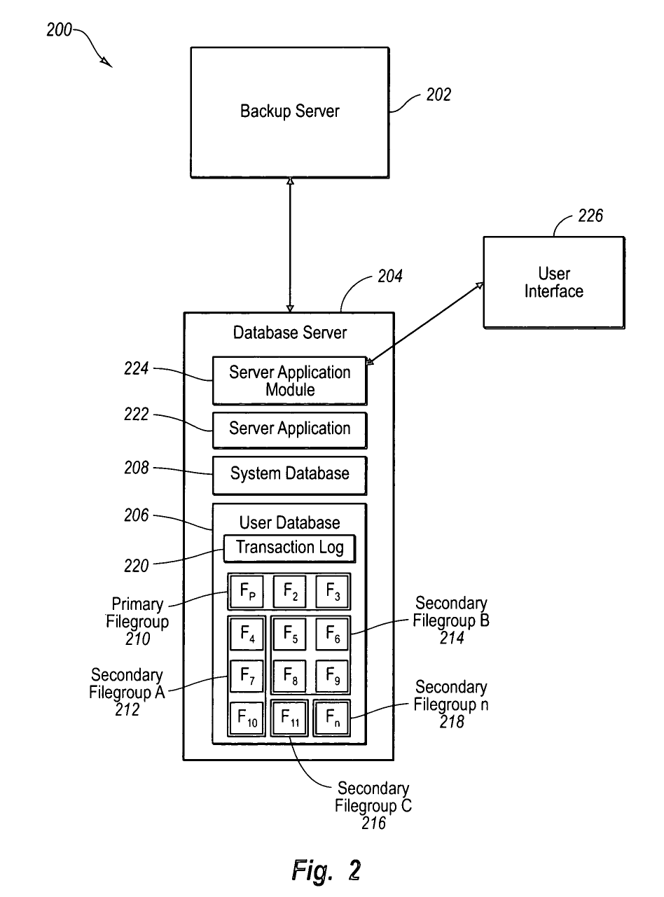

An exemplary database system 200 is shown in FIG. 2. Database system 200 includes a backup server 202, which corresponds to backup server 102 shown in FIG. 1. Database system 200 also includes database server 204. Database server 204 includes user database 206 and system database 208. User database 206 includes two types of files: data files and log files. Data files can further be classified as primary data files and secondary data files. The primary data file in user database 206 is illustrated as file F_{P}. The primary data file F_{P} includes information about the locations of all the files in user database 206. The secondary data files in user database 206 are illustrated as files F₂-Fₙ. Files F_{P}-Fₙ are further organized into two types of filegroups: a primary filegroup 210 and secondary filegroups A 212, B 214, C 216, and n 218. Each filegroup can have one or more data files, but each file can belong to only one filegroup. Primary filegroup 210 must include the primary data file F_{P}, but can also include any number of secondary data files. As illustrated, primary filegroup 210 includes files F_{P}, F₂, and F₃, secondary filegroup A 212 includes files F₄, F₇, and F₁₀, secondary filegroup B 214 includes files F₅, F₆, F₈, and F₉, secondary filegroup C 216 includes file F₁₁, and secondary filegroup n 218 includes file Fₙ. System database 208 stores information concerning which files F_{P}-Fₙ are included in which filegroups. Information concerning which files F_{P}-Fₙ are included in which filegroups can also be stored in user database 206.

User database 206 also includes a transaction log 220 which stores information about each transaction executed on user database 206. The term “transaction” as used in this application is defined as any modification to data in a database. Some examples of transactions are adding data to a database, updating data in a database, or deleting data from a database. When a transaction is executed on user database 206, a server application 222 updates transaction log 220 of user database 206 with information concerning the transaction. Server application 222 continually monitors the transactions executed on user database 206 and records each transaction in transaction log 220 of user database 206. For example, when a piece of data is deleted from user database 206, this delete transaction is detected by server application 222 and recorded in transaction log 220 of user database 206. Likewise, when a filegroup is modified on user database 206, server application 222 updates system database 208 and/or user database 206 with information concerning the filegroup, including which files are included in the filegroup.

Database server 204 of database system 200 also includes a server application module 224. A module, such as server application module 224, is a piece of code capable of performing a function, such as backup and/or restore of user database 206. For example, the function performed by server application module 224 could be a backup and/or restore of Microsoft SQL Server 2005 databases, in which case user database 206 and system database 208 are Microsoft SQL Server 2005 databases, and server application 222 is a Microsoft SQL Server 2005 application. Although exemplary database system 200 may be used in conjunction with Microsoft SQL Server 2005 databases and applications, exemplary database system 200 is not limited to use with Microsoft SQL Server 2005 databases and applications. The functions performed by server application module 224, within database server 204, are an integral part of backup and restore operations within database system 200.

Information regarding the filegroups defined on user database 206 can be stored in system database 208 and/or user database 206. Server application module 224 can access this information by contacting server application 222 which then reads the table entries in system database 208 or user database 206 regarding the filegroups defined on user database 206. System database 208 and/or user database 206 will contain information about which files are included in each filegroup defined on user database 206.

Finally, server application module 224 of database 204 of database system 200 also includes a user interface 226. User interface 226 of server application module 224 can be used by a database administrator to simplify database backup and restore operations of user database 206.

### III. Restore Processes—Including Piecemeal Restore

In operation, backup and restore processes on database system 200 can be initiated by an administrator of database system 200 or by backup server 202. When a backup operation is initiated, backup server 202 sends a backup command to server application module 224 located on database server 204. Server application module 224 then performs the backup operation on user database 206. Likewise, when a restore operation is initiated, backup server 202 sends a restore command to server application module 224 located on database server 204. Server application module 224 then performs the restore operation on user database 206. Alternatively, a backup operation or a restore operation could originate at database server 204 itself. Therefore, the command to perform a backup or restore operation need not be sent from backup server 202, but could be initiated directly on database server 204.

One type of restore operation that can be performed on user database 206 is known as “piecemeal restore.” Piecemeal restore involves restoring the filegroups of a database in multiple stages. Piecemeal restore is useful in situations where it is necessary to restore certain filegroups as quickly as possible. Since piecemeal restore allows a database to be brought online when less than all filegroups have been restored to the database, a piecemeal restore operation can bring critical filegroups online more quickly that a full restore operation where the entire database must be restored before the database will be online and accessible to database users. Generally, piecemeal restore allows database filegroups to be restored according to any priority scheme that may be desired.

In any piecemeal restore operation, the filegroups can either be restored to the database from which they originated or to some other database with database structure identical to the database structure of the original database. The database from which the filegroups originated will be referred to herein as the “origin database.” The database to which the filegroups will be restored will be referred to herein as the “destination database.” As noted above, the destination database for filegroups involved in a piecemeal restore operation can be either the origin database or another database with database structure identical to the database structure of the origin database.

As noted earlier, a piecemeal restore operation is carried out in multiple stages. In a piecemeal restore operation where user database 206 is the origin database, all filegroups in user database 206 are offline and inaccessible before the first stage of the piecemeal restore operation. During the first stage, the primary filegroup 210 must be restored. The primary filegroup 210 must be restored during the first stage because it contains primary data file F_{P} which includes information about the locations of all the files in user database 206. The files in primary filegroup 210 also contain other information which is critical to user database 206. In addition to the primary filegroup 210, any number of secondary filegroups can also be restored during the first stage. Transaction log 220 will also be restored during the first stage of the piecemeal restore operation.

After the completion of the first stage, the restored filegroups will be online and accessible in the destination database, while the filegroups that have not yet been restored will remain offline and inaccessible. During each subsequent stage of the piecemeal restore operation, one or more offline filegroups can be restored and brought online. The piecemeal restore operation can continue until the last offline filegroup is restored and brought online. Alternatively, a database administrator may choose to allow one or more filegroups to remain offline indefinitely, in which case the piecemeal restore operation can be considered complete before all filegroups are restored and brought online.

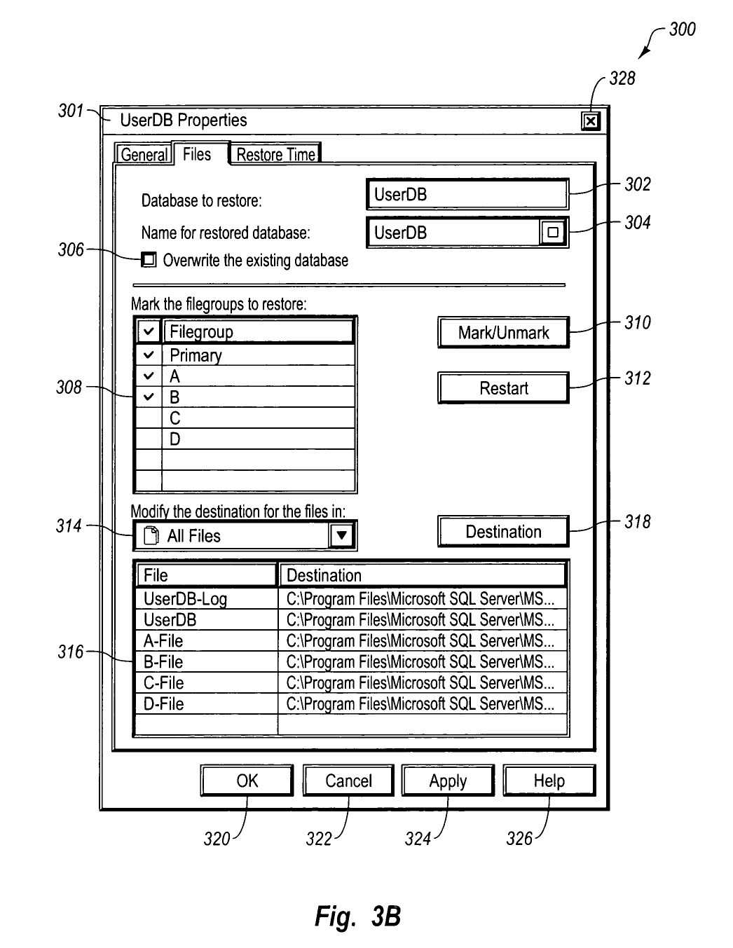

Specific details regarding an exemplary piecemeal restore operations performed in connection with a user interface are provided below in connection with a discussion of FIGS. 4-6. However, one example of a piecemeal restore operation on user database 206 is generally described as follows. During the first stage of the piecemeal restore operation, a database administrator chooses to restore primary filegroup 210, as well as secondary filegroup C 216, to user database 206, where user database 206 is both the origin and destination database in this example. In order to execute the first stage, the database administrator must formulate a database command configured to restore primary filegroup 210 and secondary filegroup C 216 to user database 206. The database administrator can use a user interface as described below in connection with a discussion of FIGS. 4-6 to formulate this and all subsequent restore commands. After completion of the first stage, the files in primary filegroup 210 and secondary filegroup C 216 will be online and accessible to database users. In other words, the data in database files F_{P}, F₂, F₃, and F₁₁ will be online and accessible to database users. Secondary filegroups A 212, B 214, and n 218, however, will remain offline and, consequently, the data in files F₄-F₉ and Fₙ will not be accessible to database users. In this example, transaction log 220 will also be restored to user database 206 during the first stage.

Continuing with the piecemeal restore example, during the second stage of the piecemeal restore operation, the database administrator chooses to restore secondary filegroup n 218. In order to execute the second stage, the database administrator must formulate a command configured to restore secondary filegroup n 218 to user database 206. After the completion of the second stage, secondary filegroup n 218 will be online, and the data in files F₉ and Fₙ will be accessible to database users. Secondary filegroups A 212 and B 214, however, will remain offline and the data in files F₄-F₇ and F₁₀ will not be accessible to database users. During the third stage of the piecemeal restore operation, the database administrator chooses to restore secondary filegroups A 212 and B 214. In order to execute the third stage, the database administrator must formulate a command configured to restore secondary filegroups A 212 and B 214. After completion of the third stage, all filegroups of user database 206 will be online, and all data in files F_{P}-Fₙ will be accessible to database users. After the execution of the third stage, the piecemeal restore operation is complete.

A piecemeal restore operation can have as few as one stage and as many stages as there are filegroups in the database. Likewise, other than the constraint that the primary filegroup be restored during the first stage, the filegroups in the database can be restored in any order that the database administrator designates. Typically, the database administrator will restore those filegroups which contain the most critical data first, and will subsequently restore those filegroups with less critical data. This allows the most critical data to become accessible to database users without requiring those users to wait for less critical data to come online.

### IV. Exemplary Graphical User Interfaces for Piecemeal Restore

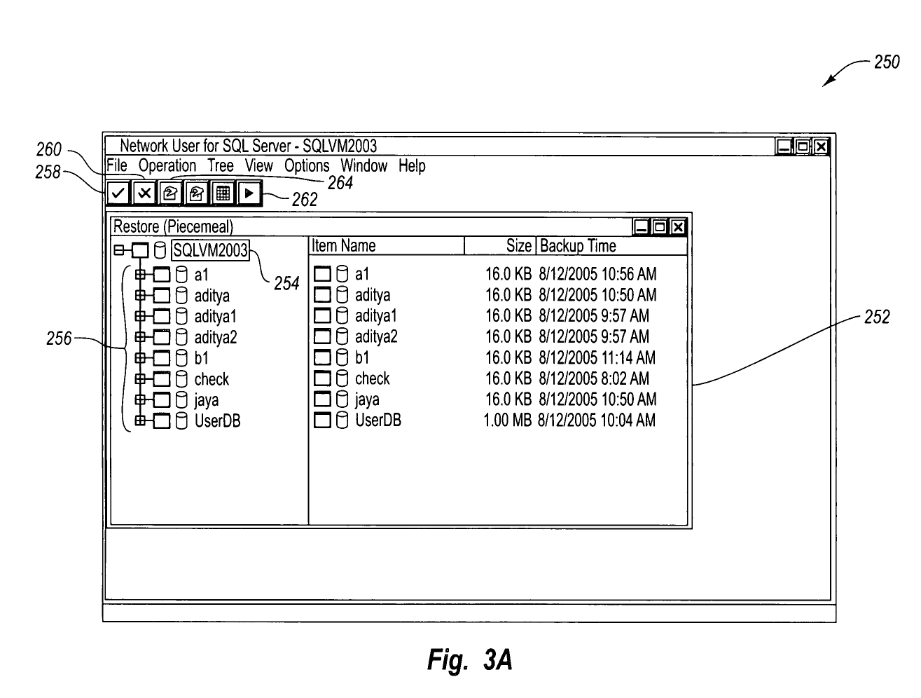

Each command formulated in order to execute each stage of a piecemeal restore operation on user database 206, as described in connection with FIG. 2, can be formulated and executed using a software application which includes the exemplary graphical user interfaces (GUIs) 250 and 300 illustrated in FIGS. 3A and 3B. In general, the GUI 250 of FIG. 3A is a graphical user interface of a database backup and restore software application. GUI 250 can be utilized by a database administrator to execute each stage of a piecemeal restore operation.

GUI 250 will be automatically presented to the database administrator upon running the underlying software application. GUI 250 could also be configured to be automatically presented to the database administrator upon the occurrence of other triggering events. GUI 250 presents the database administrator with a “Restore (Piecemeal)” window 252 which identifies a database server 254 as well as a list of databases 256 which reside on the database server 254. Each database is listed next to a checkbox which can be checked by highlighting the database and selecting a check button 258. The checkbox associated with a database can be unchecked by highlighting the database and selecting an uncheck button 260. Each database that is checked by a database administrator will have the upcoming piecemeal restore operation stage for that database performed when the execute button 262 is selected by the database administrator. In one implementation, the GUI 250 allows only one database to be checked prior to selecting the execute button 262 and, therefore, only one database can have a piecemeal restore operation stage performed each time the execute button 262 is selected.

As described above, a piecemeal restore operation on a database is performed in stages. In order to configure the upcoming stage of a piecemeal restore operation for a database before executing the upcoming stage, a database administrator can highlight a database and select the files properties button 264 in order to open the properties dialog GUI 300 of FIG. 3B.

Turning now to FIG. 3B, in general, the GUI 300 is a properties dialog that can be utilized by a database administrator to automatically formulate and configure commands to execute stages of a piecemeal restore operation on a database. By simply initializing GUI 300, the database administrator will automatically be presented with the list of all database filegroups and corresponding files that are then offline for the database that was highlighted on GUI 250 of FIG. 3A. GUI 300 allows the database administrator to select one or more of these offline filegroups to bring online. Likewise, GUI 300 enables the database administrator to easily modify the physical destination of any file contained in any of the files associated with the filegroups listed. In addition, GUI 300 enables the database administrator to restart the current piecemeal restore operation for the database that was highlighted on GUI 250 of FIG. 3A, as discussed in further detail below.

Upon initialization of GUI 300 of FIG. 3B, a label 301 and a textbox 302 on GUI 300 identify the name of the origin database, which will be the database that was highlighted on list of databases 256 of GUI 250 of FIG. 3A. GUI 300 also includes several data controls that can be used by a database administrator to configure a command to execute the upcoming stage of the current piecemeal restore operation.

A dropdown textbox 304 of GUI 300 allows the database administrator to designate the name for the destination database. As noted above, the destination database for filegroups involved in a piecemeal restore operation can be either the origin database or another database. Where the name designated in dropdown textbox 304 is identical to the name of the origin database, the filegroup(s) will be restored to the origin database during the upcoming stage of the piecemeal restore operation. In other words, the destination database for the upcoming stage will be the same as the origin database.

A database administrator could, however, use the functionality of dropdown textbox 304 to designate a destination database other than the origin database, in which case the filegroup(s) restored during the upcoming stage of the piecemeal restore operation would be restored to a database different from the origin database. The drop down list box 304 also allows the database administrator to specify a new database name which is not listed in the drop down list. Specifying a database name that is not then in the drop down list will cause the creation of a new database with database structure identical to the origin database. If a database other than the origin database is specified, as noted above, the specified database must have the same database structure as the origin database in order for the piecemeal restore operation to execute properly.

A checkbox 306 labeled “Overwrite the existing database” allows the database administrator to specify whether the destination database designated in dropdown textbox 304 should be overwritten. In the case where the database designated in dropdown textbox 304 already exists, the database administrator may not desire to overwrite existing data. When checkbox 306 is unchecked, the database administrator is specifying that the destination database designated in dropdown textbox 304 should not be overwritten. When checkbox 306 is checked, the database administrator is specifying that the destination database designated in dropdown textbox 304 should be overwritten during the restore process. If checkbox 306 is unchecked and GUI 300 determines that the database designated in dropdown textbox 304 contains data, an error message (not shown) will appear to the database administrator notifying him that the database he has designated in dropdown textbox 304 contains data. By checking checkbox 306, the database administrator is indicating that any data in the destination database designated in dropdown textbox 304 is not of any use and can be overwritten during the restore process.

Upon initialization of GUI 300, a filegroup listing 308 is automatically populated with a list of all filegroups of the origin database that are then offline. Offline filegroups are those filegroups from the origin database which have not yet been restored to the destination database. Consequently, if no stages have yet been executed for the current piecemeal restore operation, and the upcoming stage is, therefore, the first stage of the current piecemeal restore operation, filegroup listing 308 will be populated with all filegroups from the origin database. When the database administrator selects one of the filegroups listed in filegroup listing 308, the selected filegroup becomes highlighted. A “Mark/Unmark” button 310 allows the database administrator to mark or unmark the highlighted filegroup. A checkmark will appear next to any filegroup that is marked, and conversely, no checkmark will appear next to any filegroup this is unmarked. Those filegroups that are marked by the database administrator will be restored during the upcoming stage of the piecemeal restore operation. Consequently, if no stages have yet been executed for the current piecemeal restore operation, and the upcoming stage is, therefore, the first stage of the current piecemeal restore operation, and if the primary filegroup in filegroup listing 308 is not marked, an error message (not shown) will appear to the database administrator requiring him to mark the primary filegroup because the primary filegroup must be restored during the first stage, for reasons given above.

GUI 300 also allows a database administrator to restart the current piecemeal restore operation anytime between the completion of the first stage and the final stage of the piecemeal restore operation. This restart functionality is implemented by selecting a “Restart” button 312. Although button 312 is labeled “Restart” in FIG. 3B, button 312 could alternatively be labeled “New Piecemeal” or any other similar label which indicates to the database administrator that the button 312 is used to restart the current piecemeal restore operation. Restarting a piecemeal restore operation is synonymous with beginning a new piecemeal restore operation. Upon selecting “Restart” button 312, the filegroup listing 308 is repopulated with all filegroups from the origin database. In effect, the functionality of “Restart” button 312 allows a database administrator to restart the current piecemeal restore operation at the first stage. Recommencing the first stage of the current piecemeal restore operation by selecting “Restart” button 312 will undo all previously completed stages of the then-current piecemeal restore operation.

GUI 300 also enables the database administrator to modify the physical destination for the actual physical files that are being restored during the piecemeal restore operation. A database is made up of one or more actual physical files that are stored on devices such as tape drives, hard disks, or removable disks, as discussed above in connection with FIG. 1. The actual physical files that make up a database can either be stored all together on a single device, such as on a single hard disk residing on a single database server, or the actual physical files can be stored on multiple devices, such as multiple hard disks. Sometimes during a piecemeal restore operation a database administrator may wish to modify the physical location where the physical files that make up a database are stored. For example, the database administrator may wish to move a physical file from one database server in a vulnerable location to another less vulnerable location.

A dropdown textbox 314 allows the database administrator to display different categories of files corresponding to the marked filegroups listed in filegroup listing 308. For example, the categories might include “All files,” “All data files,” and “All log files.” The files corresponding to the filegroups listed in filegroup listing 308 then appear in a file listing 316. As noted above, each filegroup can have one or more associated physical files. When the database administrator selects one of the files listed in file listing 316, the selected file becomes highlighted. Selecting a “Destination” button 318 opens a file dialog box (not shown) that lets the database administrator specify a new name and/or file directory path for the highlighted file. Those files whose destinations are changed by the database administrator will be renamed and/or relocated when the filegroup to which they belong is restored to the destination database.

The functionality of the “Destination” button 318 operates in conjunction with checkbox 306. If the checkbox 306 is not selected, and GUI 300 determines that a database administrator is attempting to overwrite an existing file by changing the location or name of a file to a location with an identically named file, an error message (not shown) will appear to the database administrator notifying him that a file already exists with a location and name identical to the one that he has designated in the file dialog box (not shown).

Four buttons at the bottom of GUI 300 provide additional functionality. When the database administrator selects the “OK” button 320, all changes made by the database administrator to the data controls of GUI 300 are saved and GUI 300 is closed. When the database administrator selects the “Cancel” button 322, all changes made by the database administrator to the data controls of GUI 300 are discarded and GUI 300 is closed. When the database administrator selects the “Apply” button 324, all changes made by the database administrator to the data controls of GUI 300 are temporarily saved and GUI 300 remains open. If “OK” button 320 is later selected by the database administrator, the temporarily saved changes are saved permanently. However, if “Cancel” button 322 is later selected by the database administrator, the temporarily saved changes are discarded. Selecting the “Help” button 326 opens a help dialog window (not shown) that describes the functionality of GUI 300. Finally selecting a button 328 results in identical functionality to the “Cancel” button 322; all changes made by the database administrator to the data controls of GUI 300 are discarded and GUI 300 is closed. When the changes made by the database administrator to the data controls of GUI 300 are saved and GUI 300 is closed, GUI 300 automatically generates a corresponding database command that can be executed in order to perform the upcoming stage of the piecemeal restore operation for the database identified label 301 and textbox 302 of GUI 300. The database command reflects the input provided by the database administrator.

Among other things then, the exemplary GUI 300 of FIG. 3B eliminates the need for a database administrator to manually formulate queries before each stage of a piecemeal restore operation of the database in order to determine which filegroups remain offline. GUI 300 also eliminates the need for a database administrator to formulate commands to the database in order to execute each stage of a piecemeal restore operation, or to change the destination of the files being restored during a stage of a piecemeal restore operation. Likewise, GUI 300 eliminates the need for a database administrator to formulate commands to the database in order to restart a piecemeal restore operation. GUI 300, therefore, greatly simplifies the configuration and execution of each stage of a piecemeal restore operation by the database administrator.

When the database administrator has configured the upcoming stage of a piecemeal restore operation using GUI 300 and has closed GUI 300, the database administrator will be returned to GUI 250 of FIG. 3A. All the database administrator need do in order to execute the command that was formulated by GUI 300 is select the execute button 262 of GUI 250. By selecting the execute button, the command will be executed on the database. GUI 250, therefore, enables the database administrator to automatically execute the upcoming stage of the piecemeal restore operation without formulating a command or manually sending the command to the database system.

Although GUI 250 and GUI 300 are illustrated as separate graphical user interfaces, the functionality of GUI 250 and GUI 300 could be combined into a single user interface.

### V. Exemplary Process For Piecemeal Restore Using A User Interface

As discussed above, the exemplary GUI 300 of FIG. 3B is used to formulate commands to execute each stage of a piecemeal restore operation on a database. Aspects of an exemplary process 400 for formulating and executing a stage of a piecemeal restore operation on a database are disclosed in FIG. 4. The process 400 begins at phase 402 where, in response to the occurrence of a specific event, a server application module automatically queries a database server application requesting a list of all offline filegroups for a database. The specific event at phase 402 could be any type of user-initiated or system-initiated event including, but not limited to, the user-initialization or system-initialization of the user interface discussed in connection with phase 406 below. For example, if the user interface discussed in connection with phase 406 below is the GUI 300 of FIG. 3B, and if a user initializes GUI 300 by selecting the properties button 264 of GUI 250, this initialization of GUI 300 could be the specific event that triggers the server application module to query the database at phase 402. In other words, in this example the server application module queries the database server application in response to the initialization of the user interface. Next, at phase 404, the server application module receives the list of all offline filegroups from the database server application. During the first stage of a piecemeal restore operation, or a restart of a piecemeal restore operation, the list received at stage 404 would include all filegroups for the database.

Next, at phase 406, the server application module presents the list of all offline filegroups on a user interface of the server application module. The user interface used at phase 406 can be any conceivable type of user interface, including, but not limited to, a graphical user interface, an auditory user interface, or a tactile user interface such as a braille output interface. For example, the list of filegroups presented during phase 406 could be visually displayed to the user on a graphical user interface similar to GUI 300 of FIG. 3B. Likewise, the list could be presented on an audible user interface that presents information audibly to a user. Similarly, the list could be the presented to the user through a tactile user interface such as a braille output interface.

Then, at phase 408, the server application module receives a list selection signal indicative of a selection device designating one or more of the filegroups from the list of all offline filegroups presented on the user interface. In general, the selection device used to transmit selection signals, such as the list selection signal, can be any selection device and, depending on the type of user interface, could include the click of a mouse pointer on a visual display, a voice command, or other type of input from other computer input devices. The list selection signal received at phase 408 can also reflect the result of multiple actions on the part of the user. For example, if the user interface presented at phase 406 is the GUI 300 depicted in FIG. 3B, the user might use a mouse to click on a filegroup in filegroup listing 308, click the “Mark/Unmark” button 310, and then click the “OK” button 320 to save the changes and close the GUI 300. In this example, the signal received by the server application module is made up of these three separate actions on the part of the user. It is understood that the user interface of server application module 224 could be implemented to require only one action on the part of the user in order to produce the signal received in phase 408.

Next, at phase 410, in response to the list selection signal received at phase 408, the server application module formulates a command to bring the designated one or more filegroups online. The command to bring the designated one or more filegroups online is configured to restore the one or more filegroups to a specific destination database. As described above, the destination database can be either the origin database or another database with database structure identical to the database structure of the origin database.

Next, at phase 412, the server application module receives, by way of the user interface, an execute selection signal indicative of the selection device designating an execute option on the user interface. As explained above, the selection device used at phase 412 can be any type of selection device that can be employed in connection with the user interface. At phase 414, in response to the execute selection signal received at phase 412, the server application module will send the command, formulated at phase 410, to the database server application. Finally, at phase 416, the server application module will receive confirmation from the database server application that the command was executed and the designated one or more filegroups were brought online.

Thus, by automatically presenting a list of all offline filegroups to a user upon the occurrence of a specific event, and by allowing the user to select one or more filegroups from the list, the process 400 facilitates the formulation of a command that can be executed to perform a stage of a piecemeal restore operation.

Implementation of the exemplary process 400 for formulating and executing a stage of a piecemeal restore operation on a database can be further illustrated with reference to the exemplary database system 200 of FIG. 2. Prior to phase 402, server application module 224, residing on database server 204, will have received a request to perform a piecemeal restore operation on user database 206. At phase 402, in response to a specific event, such as the initialization of user interface 226, server application module automatically sends a query to server application 222 requesting a list of all offline filegroups in user database 206. At phase 404, server application 222 will return a list to server application module 224 containing all offline filegroups defined in user database 206.

At phase 406, after server application module 224 receives the list of all offline filegroups, server application module 224 presents the list of all offline filegroups on user interface 226. As described above, interface 226 can be any type of user interface. At phase 408, server application module 224 receives a list selection signal indicative of a selection device designating one or more of the filegroups from the list of all offline filegroups presented on user interface 226. As discussed above, the list selection signal received at stage 408 can also result from multiple actions on the part of the user. For example, if the user interface presented at phase 406 is the GUI 300 depicted in FIG. 3B, the user might use a mouse to click on a filegroup in filegroup listing 308, click the “Mark/Unmark” button 310, and then click the “OK” button 320 in order to generate the list selection signal received at phase 408. In this example, the list selection signal received by the server application module is made up of these three separate actions on the part of the user. It is understood that the user interface of server application module 224 could be implemented to require only one action on the part of the user in order to produce the signal received in phase 408. As explained above, the selection device used at phase 408 can be any type of selection device that can be employed in connection with the user interface.

Next, at phase 410, in response to the list selection signal received at phase 408, server application module 224 automatically formulates a command that, when executed, will bring the designated one or more filegroups online. The command will be formulated to restore the designated one or more filegroups to user database 206 or to another database having database structure identical to user database 206. For example, if during phase 408, the primary filegroup 210 were designated to be restored, during phase 410, server application module 224 would formulate a command to restore backup copies of files F_{P}, F₂, and F₃ to user database 206 or another designated database having database structure identical to user database 206.

Next, at phase 412, server application module 224 receives an execute selection signal indicative of a selection device designating an execute option on the user interface 226. As explained above, the selection device used at phase 412 can be any type of selection device that can be employed in connection with the user interface. At phase 414, in response to the execute selection signal received at phase 412, server application module 224 will send the command to server application 222. Finally, at phase 416, server application module 224 will receive confirmation that the command was executed and the designated one or more filegroups were brought online.

The exemplary process 400 for piecemeal restore of a database thus enables a user, in response to a specific event such as the initialization of a user interface, to be automatically presented with a list of all offline filegroups. Likewise, the user interface of exemplary process 400 allows the user to simply select from the list one or more filegroups to restore during the next stage of the piecemeal restore operation and by so doing, a command is automatically formulated to bring the one or more filegroups online. Also, the user interface of exemplary process 400 allows the user to simply select an execute command option on the user interface, and by so doing, the command is executed and the one or more filegroups are automatically brought online. The piecemeal restore operation is therefore made simpler because the user is not required to have specific knowledge of command structure and syntax in order for a command to be formulated and executed.

### VI. Exemplary Process For Modifying File Destination During Piecemeal Restore

Sometimes a user may desire to modify the restore destination of one or more files in a filegroup. This may occur, for example, because the user decides to restore a file on a different data storage medium or a different directory path than the original storage medium or directory path, or the user decides to rename the file. Modifying the restore destination of a file requires that a command to execute a stage of a piecemeal restore operation be formulated with the modified destination information for the file.

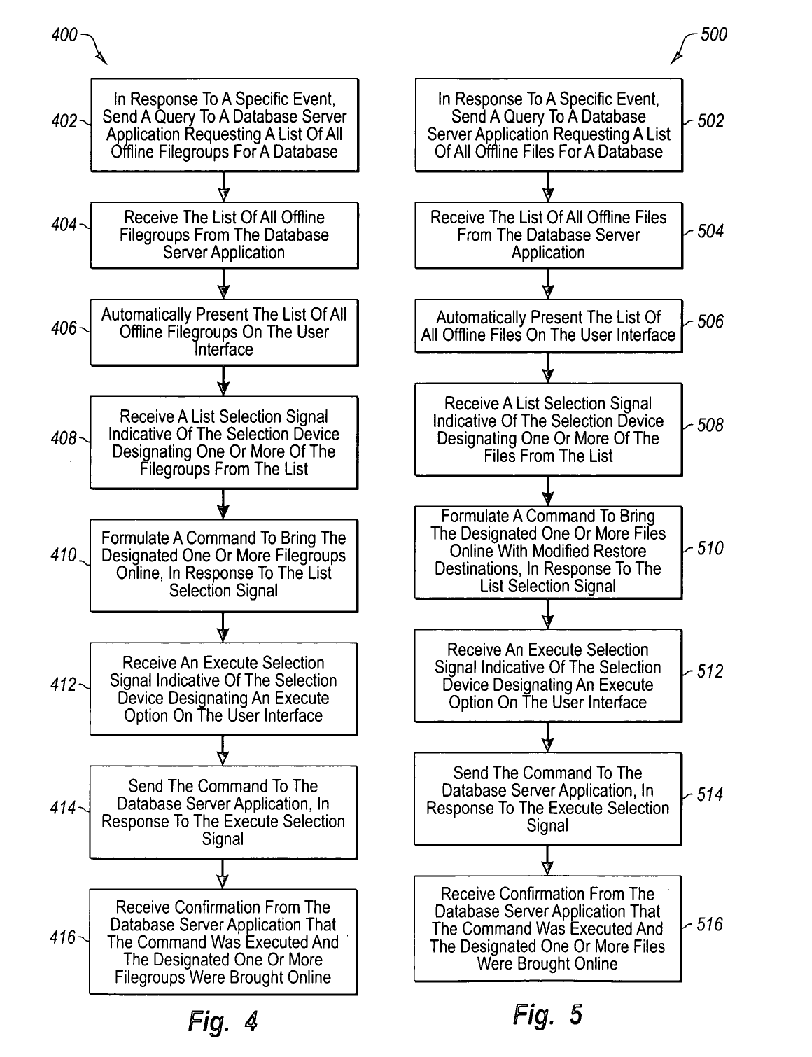

Turning now to FIG. 5, aspects of an exemplary process 500 for formulating a command to modify the restore destination of one or more files during the execution of a stage of a piecemeal restore operation on a database are disclosed. The process 500 begins at phase 502 where, in response to the occurrence of a specific event, a server application module sends a query to a database server application to compile a list of all offline files for a database. One example of such an event is the initialization of the user interface of the server application module described in connection with phase 506. Files that have not yet been restored are known as offline files. Each file is contained within a single filegroup, and each filegroup may contain one or more files. Since piecemeal restore is performed by restoring the database by filegroups, the files returned in the list will correspond to the filegroups in the database that have not yet been restored. Next, at phase 504, the server application module receives the list of all offline files back from the database server application.

Next, at phase 506, the server application module automatically presents the list of all offline files on the user interface of the server application module. As described above in connection with process 400 of FIG. 4, the user interface of process 500 can be any type of user interface capable of presenting a list of files to a user.

Then, at phase 508, the server application module receives a list selection signal indicative of a selection device designating one or more of the files from the list of files presented on the user interface. As described above in connection with process 400 of FIG. 4, the selection device utilized can be any type of selection device capable of functioning with the user interface of phase 506 to select one or more of the files from the list.

Next, at phase 510, the server application module, in response to the list selection signal received at phase 508, formulates a command to modify the restore destination of the one or more designated files. Then, at phase 512, the server application module receives an execute selection signal indicative of a selection device designating an execute option on the user interface. As explained above, the selection device used at phase 512 can be any type of selection device that can be employed in connection with the user interface. At phase 514, in response to the execute selection signal received at phase 512, the server application module will send the command to the database server application. Finally, at phase 516, the server application module will receive confirmation from the database server application that the command was executed and the designated one or more files were brought online at the specified restore destination.

Thus, by automatically presenting a list of all offline files to the user upon initialization of the user interface, and by allowing a user to select one or more files from the list, the server application module facilitates the execution of a piecemeal restore operation on the one or more files with modified file destinations.

Implementation of the exemplary process 500 for piecemeal restore of a database can be further illustrated with reference to the exemplary database system 200 of FIG. 2. Because process 500 of FIG. 5 is similar to process 400 of FIG. 4 described above, only certain aspects of process 500 will be described below. At phase 502, in response to a specific event such as the initialization of user interface 226, server application module 224 sends a query to server application 222 requesting a list of all files in user database 206 that have not yet been restored. At phase 504, sever application module 224 receives the list of all offline files from server application 222. This list of files will consist of all the files that make up the filegroups requested at phase 402 of process 400 of FIG. 4. At phase 506, the list of files will be presented on user interface 226 in a similar fashion as the list at phase 406 of process 400, with the additional presentation of the physical directory path and filename for each file in the list.

With continued reference to FIGS. 2 and 5, at phase 508, server application module 224 receives a list selection signal indicative of a selection device designating one or more of the files from the list of files presented on user interface 226. The selection device used at phase 508 will be similar to those described in connection with phase 408 of process 400 above. The signal received at phase 508 can be the result of multiple actions on the part of the user. For example, if user interface 226 utilized in process 500 is the GUI 300 depicted in FIG. 3B, the user might use a mouse to click on a file in file listing 316, then click button 318 to open a file dialog box (not shown). On the file dialog box, the user may then specify a new directory path and/or name for the designated file. The user may then click button 320 to save the changes and close the GUI 300. In this example, the signal received by the server application module is made up of these four separate actions on the part of the user. It is understood that server application module 224 could be implemented to require only one action on the part of the user in order to produce the signal received at phase 508.

At phase 510, in response to the signal received at phase 508, server application module 224 formulates a command to execute the upcoming stage with modified restore destinations for the designated one or more files. The restore destination for a file is comprised of the physical location of the file on the data storage medium, or the directory path of the file, as well as the name of the physical file. The new destinations for the one or more files are generally transmitted in the signal received at phase 508 and designated by the user. When the command is ultimately executed, the designated one or more files will be physically restored in the restore destinations modified at phase 508.

For example, if during phase 508 the restore destination of file F_{P} was modified, during phase 510, server application module 224 will formulate a command to execute the upcoming stage that includes the modified restore destination for file F_{P}. Since file F_{P} is part of primary filegroup 210, and since a piecemeal restore operation restores a database by filegroups, the command to restore file F_{P} will include files F₂ and F₃, since these files belong to primary filegroup 210.

At phase 512, server application module 224 receives an execute selection signal indicative of a selection device designating an execute option on the user interface 226. As explained above, the selection device used at phase 512 can be any type of selection device that can be employed in connection with the user interface. At phase 514, in response to the execute selection signal received at phase 512, server application module 224 will send the command to server application 222. Finally, at phase 516, server application module 224 will receive confirmation that the command was executed and the designated one or more files were brought online.

The user interface of exemplary process 500 for piecemeal restore of a database enables a user to automatically be presented with a list of files which have yet to be restored upon initialization of the user interface. Likewise, the user interface allows the user to select the file(s) for which the user would like to modify the restore destination. By so doing, the destination of the file(s) are automatically modified during the execution of the next stage without requiring the user to formulate specific commands to modify the destination(s) of file(s). The piecemeal restore operation is therefore made simpler because the user is not required to have specific knowledge of command structure and syntax in order to perform the file modification during the piecemeal restore operation.

### VII. Exemplary Process For Restarting Piecemeal Restore Using A User Interface

Sometimes a user may desire to restart a piecemeal restore operation after fewer than all stages of the piecemeal restore operation are complete. This may occur, for example, because the user decides to change the order in which the database filegroups are brought online.

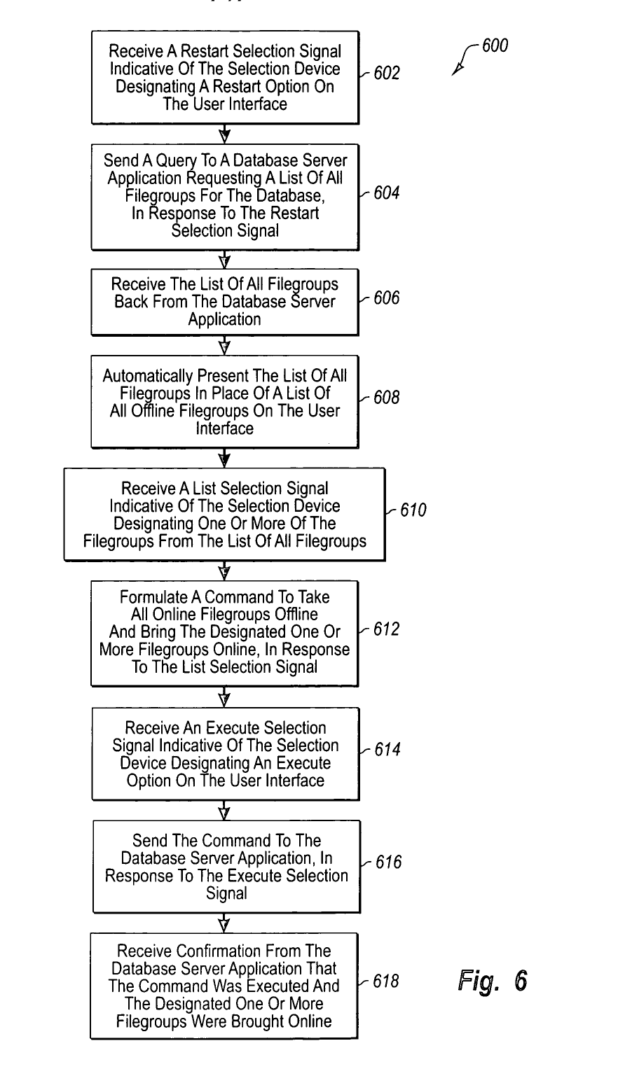

Turning now to FIG. 6, aspects of an exemplary process 600 for restarting a piecemeal restore operation are disclosed. The process 600 begins at phase 602 where the server application module receives a restart selection signal indicative of a selection device designating a restart option on the user interface.

At phase 604, in response to the restart selection signal, the server application module sends a query to the database server application requesting a list of all filegroups for the database. This list will include both online and offline filegroups for the database. At phase 606, the server application module receives the list of all filegroups from the database server application. At phase 608, the server application module automatically presents the list of all filegroups. This list replaces the previously displayed list of all offline filegroups on the user interface. Next, at phase 610, the server application module receives a list selection signal indicative of the selection device designating one or more of the filegroups from the newly presented list of all filegroups. Then, at phase 612, in response to the list selection signal, the server application module formulates a command to first take all online filegroups offline and second to bring the designated one or more filegroups online.

Next, at phase 614, the server application module receives an execute selection signal indicative of a selection device designating an execute option on the user interface. At phase 616, in response to the execute selection signal received at phase 614, the server application module will send the command to the database server application. Finally, at phase 618, the server application module receives confirmation from the database server application that the command was executed and the designated one or more filegroups were brought online.

Thus, by allowing the user to restart the piecemeal restore operation, and by allowing the user to select one or more filegroup from the list of all filegroups from the origin database, the server application module facilitates a restart of the current piecemeal restore operation by a user.

Implementation of the exemplary process 600 for piecemeal restore of a database can be further illustrated with reference to the exemplary database system 200 of FIG. 2. Because process 600 of FIG. 6 is similar to processes 400 and 500 of FIGS. 4 and 5 described above, only certain aspects of process 600 will be described below. At phase 604, server application module 224 automatically replaces the list of all offline filegroups on the user interface 226 with the list of all filegroups from user database 206. In other words, the user interface 226 will present to the user both online and offline filegroups from user database 206. At phase 612, in response to the list selection signal, server application module 224 will formulate a command that will first take all previously restore filegroups of user database 206 offline, and second will bring the designated one or more filegroups online. After phase 616, when the command is executed by database server application 222, all online filegroups of user database 206 will be taken offline and then the designated one or more filegroup will be brought online.

The user interface of exemplary process 600 enables a user to restart a piecemeal restore operation. This restart functionality is therefore made simpler and less knowledge of syntax and database commands is required in order to restart a piecemeal restore operation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computer system having a user interface and a selection device, a method for piecemeal restoration of a database, the method comprising:
sending, in response to the occurrence of a specific event, a query to a database server application requesting a list of all offline filegroups for the database;
receiving the list of all offline filegroups from the database server application;
automatically presenting the list of all offline filegroups on the user interface;
receiving a list selection signal indicative of the selection device designating one or more of the filegroups from the list; and
in response to the receipt of the list selection signal, automatically formulating a command to bring the designated one or more filegroups online.

2. The method as recited in claim 1, wherein the specific event comprises the initialization of the user interface.

3. The method as recited in claim 1, wherein automatically presenting the list on the user interface comprises automatically displaying the list on a display of the user interface.

4. The method as recited in claim 1, wherein the command is formulated to bring the designated one or more filegroups online in the database from which the one or more filegroups originated.

5. The method as recited in claim 1, wherein the command is formulated to bring the designated one or more filegroups online in a database other than the database from which the one or more filegroups originated.

6. The method as recited in claim 1, further comprising:
receiving an execute selection signal indicative of the selection device designating an execute option on the user interface;
in response to the receipt of the execute selection signal, automatically sending the command to the database server application; and
receiving confirmation from the database server application that the command was executed and the designated one or more filegroups were brought online.

7. In a computer system having a user interface and a selection device, a method for piecemeal restoration of a database, the method comprising:
sending, in response to the occurrence of a specific event, a query to a database server application requesting a list of all offline files for the database;
receiving the list of all offline files from the database server application;
automatically presenting the list of all offline files on the user interface;
receiving a list selection signal indicative of the selection device designating one or more of the files from the list; and
in response to the receipt of the list selection signal, automatically formulating a command to bring the designated one or more files online with modified restore destinations.

8. The method as recited in claim 7, wherein automatically presenting the list on the user interface comprises automatically displaying the list on a display of the user interface.

9. The method as recited in claim 7, wherein receiving a list selection signal includes receiving user-specified file locations for the designated one or more files.

10. The method as recited in claim 9, wherein automatically formulating a command includes configuring the command to modify the physical locations where the designated one or more files will be stored upon being brought online to the user-specified file locations.

11. The method as recited in claim 7, wherein receiving a list selection signal indicative includes receiving user-specified file name information for the designated one or more files.

12. The method as recited in claim 11, wherein automatically formulating a command includes configuring the command to modify the physical names of the designated one or more files upon being brought online to the user-specified file names.

13. The method as recited in claim 7, further comprising:
receiving an execute selection signal indicative of the selection device designating an execute option on the user interface;
in response to the receipt of the execute selection signal, sending the command to the database server application; and
receiving confirmation from the database server application that the command was executed and the designated one or more files were brought online.

14. In a computer system having a user interface and a selection device, a method for restarting piecemeal restoration of a database, the method comprising:
receiving a restart selection signal indicative of the selection device designating a restart option on the user interface;
in response to the receipt of the restart selection signal, sending a query to a database server application requesting a list of all filegroups for the database;
receiving the list of all filegroups from the database server application;
automatically presenting the list of all filegroups in place of a list of all offline filegroups on the user interface;
receiving a list selection signal indicative of the selection device designating one or more of the filegroups from the list of all filegroups; and
in response to the receipt of the list selection signal, automatically formulating a command to:
take all online filegroups offline; and
bring the designated one or more filegroups online.

15. The method as recited in claim 14, wherein the specific event comprises the initialization of the user interface.

16. The method as recited in claim 14, wherein the designated one or more filegroups are brought online in the database from which the one or more filegroups originated.

17. The method as recited in claim 14, further comprising:
receiving an execute selection signal indicative of the selection device designating an execute option on the user interface; and
in response to the receipt of the execute selection signal, sending the command to the database server application; and
receiving confirmation from the database server application that the command was executed and the designated one or more filegroups were brought online.

18. In a computer system having a graphical user interface, a display, and a selection device, a method for piecemeal restoration of a database, the method comprising:
automatically querying a database server application for a list of all offline filegroups for the database, in response to the initialization of the graphical user interface;
receiving the list of all offline filegroups from the database server application;
automatically displaying the list of offline filegroups on the display of the graphical user interface;
receiving a list selection signal indicative of the selection device designating one or more of the filegroups from the list of all offline filegroups displayed on the graphical user interface;
in response to the receipt of the list selection signal, automatically formulating a command to bring the designated one or more filegroup online;
receiving an execute selection signal indicative of the selection device designating an execute option on the graphical user interface; and
in response to the receipt of the execute selection signal, sending the command to the database server application; and
receiving confirmation from the database server application that the command was executed and the designated one or more filegroups were brought online.

19. The method as recited in claim 18, wherein the command is formulated to bring the designated one or more filegroups online in the database from which the one or more filegroups originated.

20. The method as recited in claim 18, wherein the command is formulated to bring the designated one or more filegroups online in a database other than the database from which the one or more filegroups originated.
